(19) United States
(12) Patent Application Publication
(10) Pub. No.: US 2026/0250547 A1
(43) Pub. Date: Aug. 27, 2026

(54) METHODS FOR ADHERING PARTICULATES TO A SUBSTRATE AND COMPOSITIONS SUITABLE FOR USE THEREIN

(71) Applicant: The Glad Products Company, Oakland, CA (US)

(72) Inventors: Elizabeth Anne WILDER, West Chester, OH (US); Jeffrey Scott STIGLIC, New Lenox, IL (US)

(21) Appl. No.: 19/064,840

(22) Filed: Feb. 27, 2025

(51) Int. Cl. C09D 183/06; C09D 7/61; C09D 7/65

(52) U.S. Cl. CPC C09D 183/06; C09D 7/61; C09D 7/65

(57) ABSTRACT

Compositions including oil-soluble film former materials to adhere particulates to substrates without excessive delamination or flaking of the particulates from a product utilizing the coated substrates. Silicone-based materials, particularly silicone gum resins and silicone crosspolymers, are well suited oil-soluble film formers. Particulates comprising hygroscopic material or moisture-activatable material can be included in the compositions since the film former is oil-soluble.

### FIELD

The present disclosure generally relates to methods for adhering particulates to a substrate and anhydrous compositions useful in such methods.

### BACKGROUND

It can be desirable to adhere functional particulates to a substrate to provide a benefit from a product embodying the substrate. For example, it can be desirable to adhere particulates to film substrates used in packaging or trash bags to impart an odor-reducing benefit. In this application, the particulates can include materials such as activated carbon to adsorb odor molecules, or superabsorbent polymers that absorb liquid to prevent leaks, or moisture-activatable particles that contain fragrance materials which can be released upon the particles encountering moisture. It can however be difficult to adhere particulates to many low surface energy substrates like the polymeric films typically used in trash bags. The particulates can flake or delaminate from the polymeric film. In addition, if the particulates contain moisture-sensitive particles, then many known aqueous solvents will not work due to interference with the particles. A need accordingly exists for improved methods of adhering particulates to substrates and compositions suitable for use therein.

### SUMMARY

Methods for adhering particulates to substrates and compositions for use in the methods are provided herein. The methods and compositions are particularly useful for adhering particulates comprising hygroscopic material to low surface energy films.

### BRIEF DESCRIPTION OF THE DRAWINGS

The above-mentioned and other features and advantages of the present disclosure, and the manner of attaining them, will become more apparent and the disclosure itself will be better understood by reference to the following description of example forms of the disclosure taken in conjunction with the accompanying drawings, wherein:

FIG. 1 is a flow diagram of an exemplary method of adhering particulates to a substrate;

FIG. 2 is a flow diagram of another exemplary method of adhering particulates to a substrate; and

FIG. 3 is a side view of a substrate containing a film former coating and particulates on one of its surfaces.

### DETAILED DESCRIPTION

Reference within the specification to “form(s)”, “aspect(s)”, “embodiment(s)” or the like means that a particular material, feature, structure and/or characteristic described in connection with the form/aspect/embodiment is included in at least one form/aspect/embodiment, optionally several forms/aspects/embodiments, but it does not mean that all forms/aspects/embodiments incorporate the material, feature, structure, and/or characteristic described. Furthermore, materials, features, structures and/or characteristics may be combined in any suitable manner across different forms/aspects/embodiments, and materials, features, structures and/or characteristics may be omitted or substituted from what is described. Thus, forms/aspects/embodiments described herein may comprise or be combinable with elements or components of other forms/aspects/embodiments despite not being expressly exemplified in combination, unless otherwise stated or an incompatibility is stated.

All numeric ranges are inclusive and combinable. For example, all numeric ranges are inclusive of narrower ranges, and delineated upper and lower range limits are interchangeable to create further ranges not explicitly delineated.

As used herein, the term “coating” means a quantity or thickness of material. The coating can be continuous, discontinuous, or even exist in a pattern. The coating need not be separable intact from a substrate material to which it is associated.

As used herein, the term “flexible” refers to materials that are capable of being flexed or bent, especially repeatedly, such that they are pliant and yieldable in response to externally applied forces. Accordingly, “flexible” is substantially opposite in meaning to the terms inflexible, rigid, or unyielding. Flexible materials may exhibit “elastic-like” behavior, meaning that when subjected to an applied strain, the materials extend in the direction of applied strain, and when the applied strain is released the materials return, to a degree, to their pre-strained condition.

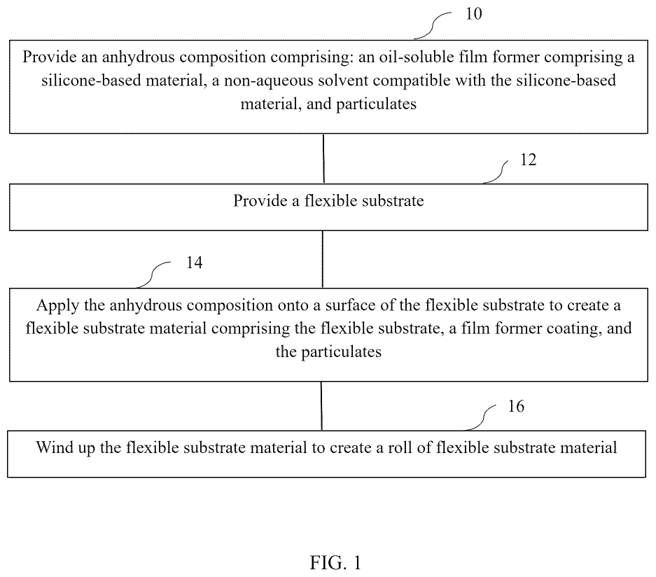

Improved methods for adhering particulates to a substrate are provided herein. FIG. 1 illustrates an exemplary method comprising a step 10 of providing an anhydrous composition that includes an oil-soluble film former, a non-aqueous solvent, and particulates. A flexible substrate is provided in step 12. The anhydrous composition is applied to the flexible substrate in step 14, resulting in a flexible substrate material that contains the flexible substrate, a film former coating, and the particulates. Step 16 involves winding the flexible substrate material up to create a roll of the same to be used in downstream manufacturing processes that convert the flexible substrate material into intermediate or final products. The step of applying the anhydrous composition can be achieved by, for example, spraying the composition onto the flexible substrate. The solvent evaporates or is driven off (for example, by ovens or heaters) sufficiently to create a dried film former coating.

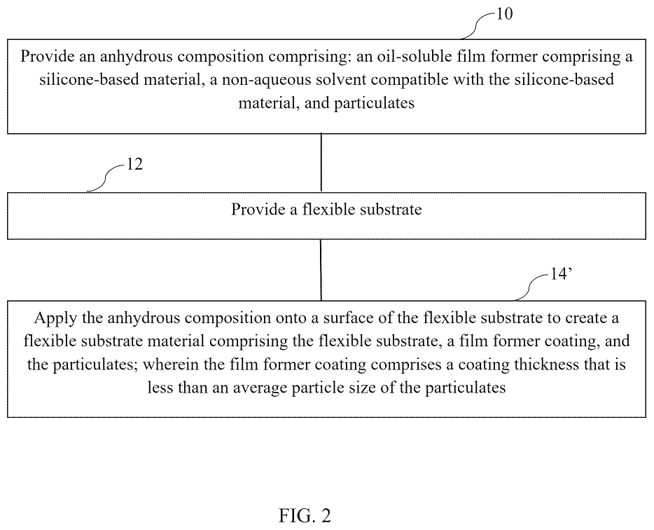

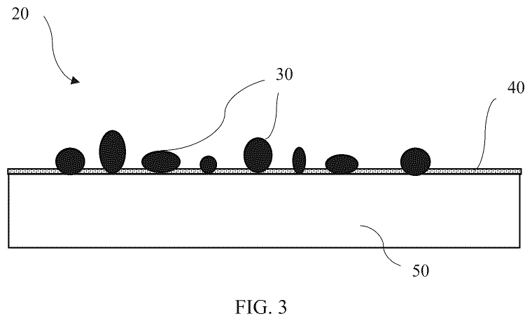

Another exemplary method is shown in FIG. 2, which comprises steps 10 and 12, as well as a step 14′, which is like step 14 above, wherein the resulting film former coating has a thickness that is less than an average particle size of the adhered particulate material. A visual of this result is provided in FIG. 3. A flexible substrate material 20 includes particulate material comprising particles 30 of various size and shape, and a film former coating 40 that binds particles 30 to a surface of flexible substrate 50. It should be understood that FIG. 3 is merely a schematic and that the present disclosure is not limited to aspects shown in FIG. 3. In one form, and as can be seen in FIG. 3, film former coating 40 has a thickness that is significantly less than an average particle size of particles 30. For example, film former coating 40 can have a thickness that is less than 10%, 6%, or 5% of the particle size of at least 80%, 90%, or 95% of the collection of particles 30.

Compositions suitable for use in the methods described herein are generally considered anhydrous. The compositions comprise an oil-soluble film former that can include a silicone-based material. Silicone resin gums and silicone crosspolymer are two exemplary silicone-based materials. Commercial forms of these materials include DOWSIL FC-5002 and DOWSIL FC-5004, both of which comprise a trimethylsiloxysilicate/dimethiconol crosspolymer dissolved in a low viscosity carrier such as dimethicone or isododecane. Other oil-soluble film former materials may be used provided they sufficiently bind particulates to a substrate without excessive delamination or flaking. By way of example only, silicone acrylates may be a suitable film former for use in the methods and compositions provided herein. DOWSIL FA-4004ID is a commercially available silicone acrylate, which includes an acrylate/polytrimethylsiloxy-methacrylate copolymer dissolved in isododecane. The film former material is typically included in the composition at levels from about 5% to about 30%, by weight of the composition. But other inclusion amounts are possible.

The oil-soluble film former is employed to bind particulates to the substrate. The methods and compositions provided herein can be used for adhering a variety of different particulates to a substrate. In one form, the particulate material comprises hygroscopic material. The hygroscopic material can be sourced from nature, including cellulosic materials. Superabsorbent polymers are one preferred category of hygroscopic materials. A superabsorbent polymer is capable of absorbing and retaining many times its own weight in fluids (e.g., water). Superabsorbent polymers and copolymers include, but are not limited to, partially neutralized hydrogel-forming gelling materials, such as polyacrylate gelling material and acrylate grafted starch gelling material, for example, potassium acrylate, sodium acrylate, potassium polyacrylate, sodium polyacrylate, solution polymers, and superabsorbent fibers. Sodium polyacrylate, for example, is a hydrophilic polymer material that can hold up to 20 times its weight in water and, in some instances, up to 1000 times its weight in water. Superabsorbent polymers are typically available as particulates, flake-like crystals, or fibers.

Hygroscopic particulate materials can be particularly useful when the coated substrates are used in trash bags because when liquids are discarded (e.g., partially consumed beverages, etc.) into a trash bag, the liquids can flow toward a bottom of the bag. The filled or partially filled trash bag can sustain tears, rips, punctures, or other failures due to heavy weight of the trash and/or sharp objects in the trash, among other causes. Consequently, the liquids can flow through the tears, rips, or punctures and out of the bag, thereby causing leaks into the trash receptacle and/or onto floors or the ground when transporting the bag to a dumpster. Adhered superabsorbent particulates can mix with the liquid to form a gel or paste that has a high viscosity, thereby inhibiting flow of the liquid and subsequent exit from the bag through rips or holes. Suitable examples of superabsorbent polymers include AQUA KEEP CA 180 N™.

Moisture-activatable materials is another species of particulates suitable for the disclosed compositions. Starches and cyclodextrins are two exemplary moisture-activatable materials. These materials can encapsulate releasable materials upon contact with moisture and other liquids. Such releasable materials can include fragrance and deodorizing materials. Staying with the above trash bag application example, discarded liquids can interact with the moisture-activatable materials to release fragrances, deodorizers, and the like to mitigate malodors. Cyclodextrins, for example, α- (alpha), β- (beta), and γ- (gamma) cyclodextrins, can encapsulate releasable materials but can also capture malodor molecules as an additional mechanism for managing malodors.

Particulates comprising materials other than hygroscopic and moisture-activatable materials are also contemplated herein. Non-limiting examples include zeolites, activated carbon/charcoal, silica, clay, talc, diatomaceous earth, perlite, vermiculite, carbon, kaolin, mica, barium sulfate, aluminum silicates, sodium carbonates, calcium carbonates, absorbent gelling materials, creped tissue, foams, wood pulp, cotton, cotton batting, paper, cellulose wadding, sponges, and desiccants.

Particulates of the present disclosure may further comprise odor adsorbing materials. Some suitable examples of odor adsorbing materials include activated carbon, bentonite, zeolite, biochar and metal organic frameworks.

The particulates can have a variety of different sizes and shapes (both uniform and irregular). In one form, the particulates include particles having a size from about 10 microns to about 100 microns. Other sizes can equally be employed. Typically, and even with sound quality control, the particulates within the compositions provided herein will have a distribution of sizes and shapes.

In addition to the film former and particulates, the compositions provided herein can include a non-aqueous solvent and/or rheology modifier to achieve a desired viscosity or other property that can be helpful during processing. Exemplary solvents, include, but are not limited to, isododecane, cyclopentasiloxane, dimethicone, and mixtures thereof. In one form, the solvent has a flash point above 200 degrees Fahrenheit. A suitable dimethicone solvent is XIAMETER PMX-200™.

Suitable rheology modifiers can comprise natural clay materials, such as bentonite clay and hectorite clay, hydrated silicas, ternary and quaternary magnesium silicate derivatives, waxes, amino-acid based thickeners, polydimethylsiloxane polymers, and the like. Silicone elastomers is another category of rheology modifiers suitable for use in the compositions and methods provided herein. The silicone elastomer may, for example, be chosen from at least one silicone crosspolymer dispersed in at least one oil. At least one silicone crosspolymer may, in certain embodiments, be chosen from dimethicone crosspolymers, such as dimethicone/vinyl dimethicone crosspolymers and dimethicone/phenyl vinyl dimethicone crosspolymers. In other embodiments, the silicone cross-polymer may be modified by one or more groups chosen from alkyl, polyether, polyglycerin groups. For instance, the alkyl modified silicone cross-polymers may be chosen from vinyl dimethicone/lauryl dimethicone cross-polymers, cetearyl dimethicone cross-polymers, and C30-C45 alkyl cetearyl dimethicone cross-polymers. Non-limiting examples of polyether modified silicone cross-polymers include dimethicone/PEG-10/15 cross-polymers. Exemplary alkyl and polyether modified silicone cross-polymers may be chosen, for example, from PEG-10/lauryl dimethicone cross-polymers and PEG-15/lauryl dimethicone cross-polymers. Exemplary polyglycerin modified silicone cross-polymers include dimethicone/polyglycerin-3 cross-polymers and lauryl dimethicone/polyglycerin-3 cross-polymers. Suitable silicon elastomer rheology modifiers include DOWSIL EL-9081™.

Compositions of the present invention can include other optional ingredients, including, for example, visualization aids and tack-reducing agents. Visualization aids can benefit a manufacturer and/or an end user of a product comprising the substrate with adhered particulates. Manufactures often use visualization process aids to monitor and manage quality control. Oil soluble dyes and carbon black are two exemplary visualization aid materials useful herein. Others may also be employed.

Some film former materials may create a substrate coating that has some undesirable tackiness. To manage this, a tack-reducing agent can be included in the compositions. Corn starch, commercially available from Cargil and other manufacturers, is one suitable tack-reducing agent. Other suitable tack-reducing agents can include talc, activated carbon, clay, mica, calcium carbonate, and other dusting agents.

The compositions comprising a film former material and particulates is applied to substrates (preferably, flexible substrates). Application techniques can include spraying, slot-coating, wiping, casting, and the like. Spraying the compositions is one preferred application technique. To help enable spraying and transferring compositions via pumps, pipes, and other processing-related structure, the compositions can have a relatively low viscosity, including, for example, from about 1,000 to about 10,000 centipoise, preferably from about 1,500 to about 4,000 centipoise. The compositions ideally exhibit acceptable stability. For example, the compositions can have a 2-hour Turbiscan value of less than 1.5, 1, or even 0.5. Turbiscan measures the physical stability of compositions. It uses Static Multiple Light Scattering (“SMLS”) to detect and quantity changes in a dispersion, such as, for example, creaming, sedimentation, flocculation, and coalescence. Turbiscan uses a dimensionless number called the Turbiscan Stability Index (“TSI”) to compare and characterize stability of compositions.

Flexible substrates can be made from an expansive list of materials and take many forms such as a polymeric film. Suitable thermoplastic polymers for making films include polyolefins, including polyethylene and copolymers thereof and polypropylene and copolymers thereof. The olefin-based polymers may include ethylene or propylene-based polymers such as polyethylene, polypropylene, and copolymers such as ethylene vinyl acetate (EVA), ethylene methyl acrylate (EMA) and ethylene acrylic acid (EAA), or blends of such polyolefins. Other examples of polymers suitable for use as films in accordance with the present disclosure may include elastomeric polymers. Suitable elastomeric polymers may also be biodegradable or environmentally degradable. Suitable elastomeric polymers for the film include poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinylacetate), poly(ethylene-methylacrylate), poly(ethylene-acrylic acid), oriented poly(ethylene-terephthalate), poly(ethylene-butylacrylate), polyurethane, poly(ethylene-propylene-diene), ethylene-propylene rubber, nylon, etc.

In one form, the flexible substrate comprises a linear low-density polyethylene. The term “linear low-density polyethylene” (LLDPE) as used herein is defined to mean a copolymer of ethylene and a minor amount of an olefin containing 4 to 10 carbon atoms, having a density of from about 0.910 to about 0.930, and a melt index (MI) of from about 0.5 to about 10. For example, some examples herein use an octene comonomer, solution phase LLDPE (MI=1.1; p=0.920). Additionally, other examples use a gas phase LLDPE, which is a hexene gas phase LLDPE formulated with slip/AB (MI=1.0; p=0.920). Still further examples use a gas phase LLDPE, which is a hexene gas phase LLDPE formulated with slip/AB (MI=1.0; p=0.926). One will appreciate that the present disclosure is not limited to LLDPE and can include “high density polyethylene” (HDPE), “low density polyethylene” (LDPE), and “very low density polyethylene” (VLDPE).

Flexible polymeric film substrates can have a starting gauge between about 0.1 mils to about 20 mils, suitably from about 0.2 mils to about 4 mils, suitably in the range of about 0.3 mils to about 2 mils, suitably from about 0.6 mils to about 1.25 mils, suitably from about 0.9 mils to about 1.1 mils, suitably from about 0.3 mils to about 0.7 mils, and suitably from about 0.4 mils and about 0.6 mils. The starting gauge of films may not be uniform; for example, varying along the length and/or width of the film.

A flexible substrate in the form of a thermoplastic film can include one, two, three, or more layers of thermoplastic material. For example, a thermoplastic film can include an A:B:C configuration in which all three layers vary in one or more of gauge, composition, color, transparency, or other properties. Alternatively, a tri-layer film can comprise an A:A:B structure or A:B:A structure in which two layers have the same composition, color, transparency, or other properties. In an A:A:B structure or A:B:A structure the A layers can comprise the same gauge or differing gauge. For example, in an A:A:B structure or A:B:A structure the film layers can comprise layer ratios of 20:20:60, 40:40:20, 15:70:15, 33:34:33, 20:60:20, 40:20:40, or other ratios.

In one example, a film can comprise a 0.5 mil, 0.920 density LLDPE, colored film. In another example, a film can include a three-layer B:A:B structure, where the ratio of layers can be 20:60:20. The exterior B layers can comprise a mixture of hexene LLDPE of density 0.918 and metallocene LLDPE of density 0.920. The interior A core layer can comprise a mixture of hexene LLDPE of density 0.918, butene LLDPE of density 0.918, and reclaimed resin. Additionally, the A core layer can include a pigment. For example, the A core layer can include a colorant in an amount between about 0.1 percent and about 6 percent. In yet another example, a film comprises coextruded three-layer B:A:B structure where the ratio of layers is 15:70:15. The B:A:B structure can also optionally have a ratio of B:A that is greater than 20:60 or less than 15:70. In one or more implementations, the LLDPE can comprise greater than 50% of the overall thermoplastic material in the film. A further exemplary film is a coextruded three-layer C:A:B structure where the ratio of layers is 20:60:20. The C layer can comprise an LLDPE material with a first colorant (e.g., black). The B layer can comprise an LLDPE material with a second colorant (e.g., white). The LLDPE material can have an MI of 1.0 and density of 0.920 g/cm³. The A core layer can comprise similar materials to any of the core layers described above. The A core layer can comprise a black colorant, a white colorant, or can be clear.

While the description focuses on flexible substrates, the methods and compositions provided herein can also be used to adhere particulates to non-flexible substrates.

The methods and compositions described herein can be particularly useful for adhering particulates to substrates having low surface energy, such as, for example, less than 34 dynes per centimeter. Some suitable examples of low surface energy films include polypropylene, polyethylene, and polytetrafluoroethylene.

TABLE 1
Composition Example 1

| Ingredient | Weight % |
|---|---|
| Silicon resin gum (5 cSt) | 22 |
| 70% trimethylsiloxysilicate/dimethiconol, | |
| 30% 5 cSt dimethicone carrier | |
| Dimethicone (solvent) | 15.5-30.5 |
| silicone fluid 5 cSt | |
| Silicone Elastomer (rheology modifier) | 5-10 |
| Superabsorbent polymer | 40-50 |
| Corn Starch (tack-reducing agent) | 2.50 |

### Flake Test Method

The flexible substrate material containing the film former coating and particulates is converted into a bag by folding a section of the material onto itself and sealing the side edges. The film former coating and particulates are located on an inner surface of the bag. The bag is placed into a 40° C. oven. The bag is removed at 24 hours and optionally then at 4-week intervals. A 4-inch by 20-inch section of the bag containing the film former coating and particulates is cut from the bag and weighed. The section is then held taut and stretched three times. The section is then reweighed to measure any loss of the film former coating or particulates. It is preferred that less than 5%, 1%, or even 0.1% loss at each of the measurement times. Depending on uses of the flexible substrate material, the methods and compositions herein can still however be considered useful and acceptable should there be higher flake off levels than the preferred values.

### COMPOSITION AND METHOD EXAMPLES

Two compositions were prepared for adhering activated carbon to a flexible substrate. The first composition, Example 2, was prepared with silicone-based film former and the second composition, Example 3, was prepared with a hydroxypropyl methylcellulose (“HPMC”) film former. The compositions according to Example 2 and 3, shown more fully in Table 2 below, were applied to a LLDPE film substrate and then assessed with the Flake Test Method described above.

TABLE 2
Composition Examples 2 and 3

| | Weight % |
|---|---|
| Example 2 | |
| Silicon resin gum (5 cSt) | 36 |
| 70% trimethylsiloxysilicate/dimethiconol, | |
| 30% 5 cSt dimethicone carrier | |
| Dimethicone (solvent) | 44 |
| silicone fluid 5 cSt | |
| Activated carbon | 20 |
| Example 3 | |
| HPMC premix | 86 |
| HPMC (20%) | |
| 20% aqueous dipropylene glycol solution of | |
| 1,2-benzisothiazolin-3-one (0.03%) | |
| Distilled water (79.97%) | |
| Activated carbon | 14 |

The LLDPE substrate samples containing the adhered activated carbon for each of Composition Examples 2 and 3 were assessed with the Flake Test Method. The LLDPE sample coated with Composition Example 2 exhibited little to no flaking, while the LLDPE sample coated with Composition Example 3 exhibited an unacceptable level of flaking.

### Exemplary Method and Composition Embodiments

A. A method for adhering particulates to a substrate, the method comprising the steps of:
   a. providing an anhydrous composition comprising:
      i. an oil-soluble film former comprising a silicone-based material;
      ii. a non-aqueous solvent compatible with the silicone-based material; and
      iii. particulates;
   b. providing a flexible substrate;
   c. applying the anhydrous composition onto a surface of the flexible substrate to create a flexible substrate material comprising the flexible substrate, a film former coating, and the particulates; and
   d. winding up the flexible substrate material to create a roll of flexible substrate material.
B. The method of Paragraph A, wherein the silicone-based material comprises a silicone resin gum.
C. The method of Paragraph A, wherein the silicone-based material comprises a silicone crosspolymer.
D. The method of Paragraph A, wherein the silicone-based material comprises a trimethylsiloxysilicate/dimethiconol crosspolymer.
E. The method of Paragraph A, wherein the anhydrous composition comprises from about 5% to about 30%, by weight of the composition, of trimethylsiloxysilicate/dimethiconol crosspolymer.
F. The method of any one of the preceding paragraphs, wherein the non-aqueous solvent comprises isododecane, cyclopentasiloxane, dimethicone, or a mixture thereof.
G. The method of any one of Paragraphs A to E, wherein the non-aqueous solvent has a flash point above 200 degrees Fahrenheit.
H. The method of any one of the preceding paragraphs, wherein the particulates comprises activated carbon.
I. The method of any one of the preceding paragraphs, wherein the particulates comprises a hygroscopic material.
J. The method of Paragraph I, wherein the hygroscopic material comprises a superabsorbent polymer.
K. The method of any one of Paragraphs A to G, wherein the particulates comprises a moisture-activatable material.
L. The method of Paragraph K, wherein the moisture-activatable material comprises a starch.
M. The method of Paragraph K, wherein the moisture-activatable material comprises a cyclodextrin material.
N. The method of any one of the preceding paragraphs, wherein the anhydrous composition further comprises a rheology modifier.
O. The method of Paragraph N, wherein the rheology modifier comprises a silicone elastomer.
P. The method of Paragraph N, wherein the rheology modifier comprises a natural clay material.
Q. The method of any one of the preceding paragraphs, wherein the anhydrous composition further comprises a tack-reducing agent.
R. The method of any one of the preceding paragraphs, wherein the anhydrous composition further comprises a visualization aid.
S. The method of any one of the preceding paragraphs, wherein the flexible substrate comprises a polymeric film.
T. The method of Paragraph S, wherein the polymeric film comprises a linear low-density polyethylene.
U. The method of Paragraph T, wherein the polymeric film comprises a thickness of from about 0.1 mils to about 20 mils.
V. The method of any one of the preceding paragraphs, wherein the flexible substrate comprises a surface energy of less than 32 dynes per centimeter.
W. The method of any one of the preceding paragraphs, wherein the step of applying the anhydrous composition onto a surface of the flexible substrate comprises spraying the anhydrous composition.
X. The method of any one of the preceding paragraphs, wherein the film former coating has a coating thickness.
Y. The method of Paragraph X, wherein the coating thickness is less than an average particle size of the particulates.
Z. The method of Paragraph X, wherein the coating thickness is less than 10% of a particle size of at least 80% of the particulates.
AA. The method of Paragraph X, wherein the coating thickness is less than 6% of a particle size of at least 90% of the particulates.
BB. The method of any one of the preceding paragraphs, wherein the roll of flexible substrate material is capable of releasing from itself sufficiently to unwind the roll of flexible substrate material.
CC. The method of any one of the preceding paragraphs, wherein less than 1% of the film former coating or the particulates flake off according to the Flake Test Method disclosed herein.
DD. A composition comprising particulates to be applied to a flexible, low surface energy substrate, the composition comprising:
   a. an oil-soluble film former comprising a silicone-based material;
   b. a non-aqueous solvent compatible with the silicone-based material and having a flash point above 200 degrees Fahrenheit; and
   c. particulates;
   d. a rheology modifier;
   e. wherein the composition is sprayable.
EE. The composition of Paragraph DD, wherein the composition further comprises a tack-reducing agent.
FF. The composition of Paragraph EE, wherein the tack-reducing agent comprises corn starch.
GG. The composition of any one of Paragraphs DD to FF, wherein the composition further comprises a visualization aid.
HH. The composition of Paragraph GG, wherein the visualization aid comprises carbon black.
II. The composition of any one of Paragraphs DD to HH, wherein the silicone-based material comprises a silicone resin gum.
JJ. The composition of any one of Paragraphs DD to HH, wherein the silicone-based material comprises a silicone copolymer.
KK. The composition of any one of Paragraphs DD to HH, wherein the silicone-based material comprises a trimethylsiloxysilicate/dimethiconol crosspolymer.
LL. The composition of any one of Paragraphs DD to HH, wherein the composition comprises from about 5% to about 30%, by weight of the composition, of a trimethylsiloxysilicate/dimethiconol crosspolymer.
MM. The composition of any one of Paragraphs DD to LL, wherein the non-aqueous solvent comprises isododecane, cyclopentasiloxane, dimethicone, or a mixture thereof.
NN. The composition of any one of Paragraphs DD to MM, wherein the non-aqueous solvent has a flash point above 200 degrees Fahrenheit.
OO. The composition of any one of the Paragraphs DD to NN, wherein the particulates comprises a hygroscopic material.
PP. The composition of Paragraph OO, wherein the hygroscopic material comprises a superabsorbent polymer.
QQ. The composition of any one of Paragraphs DD to NN, wherein the particulates comprises a moisture-activatable material.
RR. The composition of Paragraph QQ, wherein the moisture-activatable material comprises a starch.
SS. The composition of Paragraph QQ, wherein the moisture-activatable material comprises a cyclodextrin material.
TT. The composition of any one of Paragraphs DD to SS, wherein the particulates have an average particle size of less than 100 microns.
UU. The composition of any one of Paragraphs DD to TT, wherein the rheology modifier comprises a silicone elastomer.
VV. The composition of any one of Paragraphs DD to UU, wherein the composition comprises a viscosity of less than 4,000 centipoise.
WW. The composition of any one of Paragraphs DD to VV, wherein the composition comprises a 2-hour Turbiscan value of less than 1.5.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be understood by those skilled in the art that various other changes and modifications can be made without departing from the spirit and scope of the present disclosure. It is therefore intended to cover in the appended claims all such changes and modifications that are within the scope of the present disclosure.

What is claimed is:

1. A method for adhering particulates to a substrate, the method comprising the steps of:
a. providing an anhydrous composition comprising:
i. an oil-soluble film former comprising a silicone-based material;
ii. a non-aqueous solvent compatible with the silicone-based material; and
iii. particulates;
b. providing a flexible substrate;
c. applying the anhydrous composition onto a surface of the flexible substrate to create a flexible substrate material comprising the flexible substrate, a film former coating, and the particulates; and
d. winding up the flexible substrate material to create a roll of flexible substrate material.

2. The method of claim 1, wherein the silicone-based material comprises a silicone resin gum.

3. The method of claim 1, wherein the silicone-based material comprises a silicone crosspolymer.

4. The method of claim 1, wherein the silicone-based material comprises a trimethylsiloxysilicate/dimethiconol crosspolymer.

5. The method of claim 1, wherein the non-aqueous solvent is selected from the group comprising isododecane, cyclopentasiloxane, dimethicone, and mixtures thereof.

6. The method of claim 1, wherein the particulates comprise a superabsorbent polymer.

7. The method of claim 1, wherein the particulates comprise an odor adsorbing material.

8. The method of claim 1, wherein the flexible substrate comprises a surface energy of less than 32 dynes per centimeter.

9. The method of claim 1, wherein the flexible substrate comprises linear low-density polyethylene.

10. The method of claim 1, wherein the anhydrous composition further comprises a rheology modifier.

11. The method of claim 1, wherein the anhydrous composition further comprises a visualization aid.

12. The method of claim 1, wherein the anhydrous composition further comprises a tack-reducing agent.

13. The method of claim 1, wherein less than 1% of the film former coating or the particulates flake off according to the Flake Test Method disclosed herein.

14. A method for adhering particulates to a substrate, the method comprising the steps of:
a. providing an anhydrous composition comprising:
i. an oil-soluble film former comprising a silicone-based material;
ii. a non-aqueous solvent compatible with the silicone-based material; and
iii. particulates;
b. providing a flexible substrate; and
c. applying the anhydrous composition onto a surface of the flexible substrate to create a flexible substrate material comprising the flexible substrate, a film former coating, and the particulates;
d. wherein the film former coating comprises a coating thickness that is less than an average particle size of the particulates.

15. The method of claim 14, wherein the coating thickness is less than 10% of a particle size of at least 80% of the particulates.

16. A composition comprising particulates to be applied to a flexible, low-energy substrate, the composition comprising:
a. an oil-soluble film former comprising from about 5% to about 30%, by weight of the composition, of a trimethylsiloxysilicate/dimethicone crosspolymer;
b. a non-aqueous solvent;
c. particulates that comprise a hygroscopic material, a moisture-activatable material, an odor adsorbing material, or combinations thereof;
d. optionally a rheology modifier;
e. optionally a tack-reducing agent; and
f. optionally a visualization aid.

17. The composition of claim 16, wherein the particulates comprise a superabsorbent polymer.

18. The composition of claim 16, wherein the rheology modifier comprises a silicone elastomer.

19. The composition of claim 16, wherein the tack-reducing agent comprises corn starch.

20. The composition of claim 16, wherein the visualization aid comprises carbon black.

21. The composition of claim 16, wherein the composition comprises a viscosity of less than about 10,000 centipoise.
